(19) United States
(12) Patent Application Publication
(10) Pub. No.: US 2014/0015456 A1
(43) Pub. Date: Jan. 16, 2014

(54) VEHICLE POWER SUPPLY DEVICE

(71) Applicant: Tsuyoshi Nishio, Kanagawa (JP)

(72) Inventor: Tsuyoshi Nishio, Kanagawa (JP)

(73) Assignee: PANASONIC CORPORATION, Osaka (JP)

(21) Appl. No.: 14/008,220

(22) PCT Filed: Mar. 28, 2012
(86) PCT No.: PCT/JP2012/002159

§ 371 Date: Sep. 27, 2013

(30) Foreign Application Priority Data
Mar. 29, 2011 (JP) 2011-072267
Mar. 31, 2011 (JP) 2011-077919

(51) Int. Cl. H02P 3/14; B60L 11/18

(52) U.S. Cl. CPC H02P 3/14; B60L 11/1811
USPC 318/376; 320/109

(57) ABSTRACT

In order to prevent elements from being damaged by electrical energy when a regenerative braking force is generated, an electric motor (108) in a vehicle power supply device (100) converts the kinetic energy of a vehicle (10) into electrical energy to generate a regenerative braking force, and an inverter (103) converts AC electrical energy outputted by the electric motor (108) into DC electrical energy. The converted DC electrical energy accumulates in a battery (106) via first switches (105a, 105b) and second switches (107a, 107b). A control unit (109) switches the second switches (107a, 107b) on when electrical energy resulting from a regenerative braking force generated by the electric motor (108) is capable of accumulating in the battery.

### TECHNICAL FIELD

The present invention relates to a vehicle power supply apparatus that converts kinetic energy at the time of braking of a vehicle into electrical energy (regenerative energy) using an electric motor and stores the obtained electrical energy in a storage battery.

### BACKGROUND ART

A vehicle power supply apparatus includes: an electric motor that generates a regenerative braking force by converting kinetic energy into electrical energy; a battery that stores the electrical energy; a relay that turns On/Off the state of an electrical connection between the electric motor and the battery (for example, see Patent Literature (hereinafter, abbreviated as PTL) 1).

When a regenerative braking force is generated at the time of not a conductive state (that is, not the “On” state) of the relay, i.e., a non-conductive state (that is, the “Off” state) of the relay for some reason, the electrical energy is not stored in the battery. Accordingly, there is concern that an element such as an inverter arranged between the relay and the electric motor may be damaged due to the electrical energy.

In order to prevent damage of such an element due to the electrical energy described above, according to the technology disclosed in PTL 1, a diode is connected in parallel with the relay, thereby allowing the electrical energy to be stored in the battery through the diode even in a case where the relay is turned off as described above.

### CITATION LIST

### Patent Literature

PTL 1

Japanese Utility Model (Registration) Application Laid-Open No. 60-69590

### SUMMARY OF INVENTION

### Technical Problem

However, in the vehicle power supply apparatus of the related art (PTL 1) described above, the electrical energy is not stored in the battery through the diode until a turn-on time (time required for a voltage to be stabilized at a forward voltage after bias is applied to the diode in the forward direction) elapses. Accordingly, in the vehicle power supply apparatus of the related art described above, in a case where the relay is turned off, electrical energy flows through the inverter and/or the like during the turn-on time. Accordingly, there is concern that an element provided between the relay and the electric motor may be damaged.

The above-described problem similarly occurs in an element provided between a power receiver configured to receive electrical energy from an external power supply and a relay, in a case where the electrical energy supplied from the power supply (external power supply) disposed outside a vehicle is stored in a storage battery.

The present invention is made in view of the abovementioned points and aims at providing a vehicle power supply apparatus capable of preventing an element provided between a relay and an electric motor from being damaged due to electrical energy at the time of the generation of a regenerative braking force, or electrical energy supplied from a power supply disposed outside a vehicle.

### Solution to Problem

A vehicle power supply apparatus according to an aspect of the present invention is apparatus to be installed in a vehicle, the apparatus including: an electric motor that generates a regenerative braking force by converting kinetic energy into electrical energy; a storage battery that stores the electrical energy; a first switch that electrically connects the electric motor and the storage battery to each other; a second switch that is connected in parallel with the first switch and electrically connects the electric motor and the storage battery to each other; and a control section that controls the second switch, in which the control section turns on the second switch when the vehicle is in a predetermined state having a possibility that the electrical energy is stored in the storage battery in accordance with generation of a regenerative braking force, or when the vehicle is operated to perform a predetermined operation having the possibility.

A vehicle power supply apparatus according to another aspect of the present invention is an apparatus to be installed in a vehicle, the apparatus including: a power receiving section that receives electrical energy supplied from a power supply disposed outside the vehicle; a storage battery that stores the electrical energy outputted from the power receiving section; a first switch that electrically connects the power receiving section and the storage battery to each other; a second switch that is connected in parallel with the first switch and electrically connects the power receiving section and the storage battery to each other; and a control section that controls the power receiving section, the first switch, and the second switch, in which the control section turns on the first switch and the second switch and then outputs the electrical energy from the power receiving section when the state of the vehicle is a state in which the storage battery is chargeable and a state in which there is an indication for charging the storage battery.

### Advantageous Effects of Invention

According to the present invention, an element provided between a relay and an electric motor is prevented from being damaged due to electrical energy at the time of the generation of a regenerative braking force.

### BRIEF DESCRIPTION OF DRAWINGS

FIG. 1 is a block diagram illustrating the configuration of a vehicle power supply apparatus according to Embodiment 1 of the present invention;

FIG. 2 is an operation flowchart of the vehicle power supply apparatus according to Embodiment 1 of the present invention;

FIG. 3 is an operation timing diagram of the vehicle power supply apparatus according to Embodiment 1 of the present invention;

FIG. 4 is a block diagram illustrating the configuration of a vehicle power supply apparatus according to Embodiment 2 of the present invention;

FIG. 5 is an operation flowchart of the vehicle power supply apparatus according to Embodiment 2 of the present invention;

FIG. 6 is a block diagram illustrating the configuration of a vehicle power supply apparatus according to Embodiment 3 of the present invention; and

FIG. 7 is a block diagram illustrating the configuration of a vehicle power supply apparatus according to Embodiment 4 of the present invention.

### DESCRIPTION OF EMBODIMENTS

Hereinafter, a vehicle power supply apparatus according to each embodiment of the present invention will be described with reference to the drawings.

### Embodiment 1

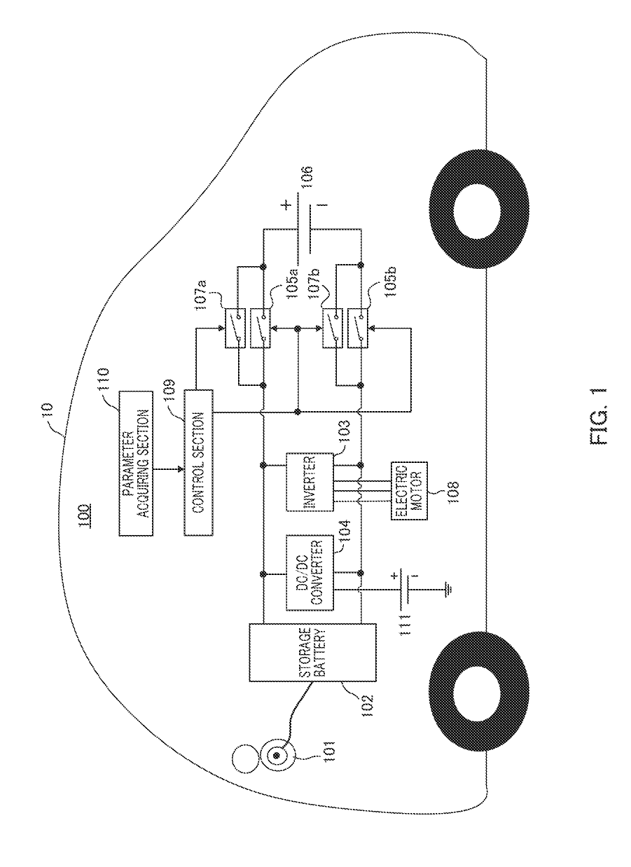

FIG. 1 is a block diagram illustrating the configuration of vehicle power supply apparatus 100 according to Embodiment 1 of the present invention.

As illustrated in FIG. 1, vehicle power supply apparatus 100 is installed in vehicle 10. Vehicle power supply apparatus 100 includes: lid section 101; charger 102; inverter 103, DC/DC converter 104; first switches 105a and 105b; second switches 107a and 107b; storage battery 106; electric motor 108; control section 109; parameter acquiring section 110; and auxiliary battery 111. Here, storage battery 106 and first switches 105a and 105b correspond to a battery and a relay of the vehicle power supply apparatus of the related art (PTL 1) described above.

Hereinafter, the operation at the time of charging storage battery 106 and the operation at the time of discharging storage battery 106 will be separately described.

First, the operation at the time of charging storage battery 106 will be described.

<Operation at Time of Charging Storage Battery 106>

At the start of charging, a power supply plug (not illustrated in the drawing) is inserted from the outside of vehicle 10 into electrodes provided in lid section 101. Storage battery 106 stores electrical energy supplied from the outside. In addition, storage battery 106, as will be described later, can store electrical energy (regenerative energy) converted by electric motor 108 at the time of generating a regenerative braking force.

Lid section 101 can be attached/detached or opened/closed by a user of vehicle 10. The user of vehicle 10 starts charging by inserting the power supply plug into lid section 101 from the outside of vehicle 10. Lid section 101 is provided with the electrodes. When the power supply plug is inserted, electrodes of the power supply plug and the electrodes of lid section 101 are brought into contact with each other, thereby enabling supply of electrical energy from the outside of vehicle 10. From the power supply plug connected to a household power supply, for example, electrical energy of about AC 100 to 240 V is supplied.

The electrical energy supplied from the power supply plug is inputted to charger 102. Charger 102 converts the AC electrical energy into DC electrical energy and outputs the converted DC electrical energy. The electrical energy converted into DC is stored in storage battery 106 through first switches 105a and 105b and second switches 107a and 107b. In addition, the DC electrical energy outputted from charger 102 is stored in auxiliary battery 111 through DC/DC converter 104.

DC/DC converter 104 performs voltage transformation of the DC electrical energy outputted by charger 102. The transformed electrical energy is outputted to be stored in auxiliary battery 111.

A shaft of electric motor 108 is connected to a vehicle shaft of drive wheels of vehicle 10 and generates a regenerative braking force by converting the kinetic energy of vehicle 10 into electrical energy. When a rotor provided in electric motor 108 is rotated by an external force (a rotation force of the vehicle shaft of drive wheels of vehicle 10), electric motor 108 serves as a power generator and generates electrical energy. Accordingly, when the kinetic energy according to the rotation of the vehicle shaft is converted into electrical energy, a regenerative braking force, which is a resistance force against the rotation of the vehicle shaft, is generated. Electric motor 108 outputs this electrical energy to inverter 103. This electrical energy is AC electrical energy.

Inverter 103 converts AC electrical energy outputted by electric motor 108 into DC electrical energy and outputs the converted DC electrical energy. The converted DC electrical energy is stored in storage battery 106 through first switches 105a and 105b and second switches 107a and 107b.

When turned on by control section 109, first switches 105a and 105b electrically connect charger 102 and storage battery 106 and electrically connect electric motor 108 and storage battery 106. On the other hand, when turned off by control section 109, first switches 105a and 105b electrically disconnect charger 102 and storage battery 106 from each other and electrically disconnect electric motor 108 and storage battery 106 from each other. For example, each one of first switches 105a and 105b is a mechanical switch including a movable contact and fixed contacts in which the fixed contacts become conductive (turned on) or non-conductive (turned off) by moving the movable contact by electromagnetic force.

Second switches 107a and 107b are electrically connected in parallel with first switches 105a and 105b. When turned on by control section 109, second switches 107a and 107b electrically connect charger 102 and storage battery 106 and electrically connect electric motor 108 and storage battery 106. In addition, when turned off by control section 109, second switches 107a and 107b electrically disconnect charger 102 and storage battery 106 from each other and electrically disconnect electric motor 108 and storage battery 106 from each other. For example, second switches 107a and 107b, similarly to first switches 105a and 105b, are mechanical switches. Second switches 107a and 107b, as will be described later, are used for preventing elements (for example, inverter 103 and DC/DC converter 104) provided between first switches 105a and 105b and electric motor 108 from being damaged due to the electrical energy at the time of generating a regenerative braking force in the electric motor 108.

First switch 105a and second switch 107a are arranged on the positive electrode side of storage battery 106. In addition, first switch 105b and second switch 107b are arranged on the negative electrode side of storage battery 106.

Here, it is preferable that the on-resistance values of first switches 105a and 105b be smaller than the on-resistance values of second switches 107a and 107b. Accordingly, the current flowing through second switches 107a and 107b is smaller than the current flowing through first switches 105a and 105b, whereby the stress applied to second switches 107a and 107b due to the current decreases. Accordingly, deterioration of second switches 107a and 107b can be suppressed.

Storage battery 106 stores DC electrical energy outputted by charger 102 and DC electrical energy outputted by inverter 103. As storage battery 106, a secondary battery (such as a nickel hydride rechargeable battery or a lithium ion rechargeable battery) having a high energy density or a high-capacity capacitor is used.

Control section 109 controls On/Off of first switches 105a and 105b and second switches 107a and 107b based on various parameters inputted from parameter acquiring section 110. Control section 109 is configured using a CPU, a ROM or a RAM, and the like. The CPU executes a program stored in the ROM, the RAM, or the like, thereby performing various calculations, output of control signals, and the like. The control process performed by control section 109 will be described later in detail.

Parameter acquiring section 110 acquires various parameters necessary for the control process performed by control section 109 and outputs the acquired parameters to control section 109.

Next, the operation at the time of discharging storage battery 106 will be described.

<Operation at Time of Discharging Storage Battery 106>

The electrical energy stored in storage battery 106, for example, is used as power for operating electric motor 108 as a power supply for driving the drive wheels of vehicle 10. In a case where electric motor 108 is used as a motor, inverter 103 converts DC electrical energy stored in storage battery 106 into AC electrical energy and outputs the converted AC electrical energy to electric motor 108. The shaft of electric motor 108 is connected to the vehicle shaft of the drive wheels of vehicle 10, and the drive wheels of vehicle 10 rotate in accordance with the rotation of the shaft.

In addition, the electrical energy stored in storage battery 106 is used as power for operating, for example, accessory apparatuses such as a car navigation apparatus and a car audio and electric components such as a power window, an ETC (registered trademark), and an electronic control unit (ECU) through DC/DC converter 104. In addition, the electrical energy stored in storage battery 106 is stored in auxiliary battery 111 through DC/DC converter 104. In such a case, DC/DC converter 104 performs voltage transformation of the DC electrical energy outputted from storage battery 106.

As described above, the operations at the time of charging and discharging storage battery 106 have been described.

Next, the control process of first switches 105a and 105b and second switches 107a and 107b, which is performed by control section 109, will be described.

First, the control of first switches 105a and 105b will be described.

Parameter acquiring section 110 acquires a signal representing that the ignition of vehicle 10 is turned on by an ignition key and inputs the acquired signal to control section 109. Control section 109 determines whether or not the ignition of vehicle 10 is turned on based on whether this signal has been inputted. In a case where the ignition is turned on, control section 109 turns on first switches 105a and 105b. The reason for this is that, when the ignition is turned on, in order to enable the driving of vehicle 10, storage battery 106 needs to be electrically connected to each section. On the other hand, in a case where the ignition is not turned on, control section 109 turns off first switches 105a and 105b and second switches 107a and 107b. The reason for this is that, when first switches 105a and 105b are turned off, vehicle 10 is stopped, and there is no electrical energy outputted from electric motor 108, and second switches 107a and 107b may be turned off. Here, instead of turning-on of the ignition using the ignition key, a signal representing the turning-on of the ignition using a push-type start button or a key using radio waves may be used.

Next, the control of second switches 107a and 107b will be described.

As below, control section 109 turns on second switches 107a and 107b when there is a possibility that electrical energy is stored in storage battery 106 in accordance with the generation of a regenerative braking force in electric motor 108. In addition, control section 109 determines whether or not there is a possibility that electrical energy is stored in storage battery 106 in accordance with the generation of the regenerative braking force in electric motor 108 based on various parameters inputted from parameter acquiring section 110.

As below, control section 109 predicts the generation of a regenerative braking force and turns on second switches 107a and 107b in advance before electrical energy is outputted from electric motor 108 in preparation for the generation of the regenerative braking force. Accordingly, even in a case where turn-on times are required for second switches 107a and 107b, second switches 107a and 107b can be electrically connected until a time point when the electrical energy is outputted from electric motor 108. Therefore, according to this embodiment, even in a case where turn-on times are required for second switches 107a and 107b, the elements (for example, inverter 103 and DC/DC converter 104) provided between first switches 105a and 105b and electric motor 108 can be prevented from being damaged due to the electrical energy at the time of generating a regenerative braking force in electric motor 108. In other words, according to this embodiment, even in a case where first switches 105a and 105b are non-conductive due to breakdown or the like at the time of generating a regenerative braking force, the electrical energy outputted from electric motor 108 can be surely stored in storage battery 106 through second switches 107a and 107b, and accordingly, damages in elements provided between first switches 105a and 105b and electric motor 108 can be prevented.

Hereinafter, an example of the control process of second switches 107a and 107b will be described with a plurality of determination parameters being illustrated as an example.

### Control Example 1

### When Determination Parameters Include Acceleration of Vehicle 10

When the determination parameters include acceleration of vehicle 10, parameter acquiring section 110 is configured using an acceleration sensor, and the acceleration of vehicle 10, which is acquired by the acceleration sensor, is inputted to control section 109.

When the acceleration of vehicle 10 is in the state of changing from positive acceleration to negative acceleration, control section 109 determines that there is a possibility that electrical energy is stored in storage battery 106 in accordance with the generation of a regenerative braking force in electric motor 108 and thus turns on second switches 107a and 107b in preparation for the generation of the regenerative braking force.

The reason behind for this is that, when the acceleration of vehicle 10 changes from positive acceleration to negative acceleration, vehicle 10 is in a decelerating state, so that there is a possibility that a regenerative braking force is generated in electric motor 108.

In addition, when vehicle 10 is under automatic controlled so as to maintain a predetermined speed, control section 109 may determine that there is a possibility of the acceleration of vehicle 10 changing from positive acceleration to negative acceleration and turn on second switches 107a and 107b. In such a case, control section 109 inputs a signal representing to control vehicle 10 so as to maintain a predetermined speed. For example, in the case of automatic driving using an in-vehicle camera imaging the front side of vehicle 10 or the like, vehicle 10 is automatically controlled to maintain a predetermined speed.

Furthermore, when vehicle 10 is automatically controlled so as to avoid an interference object other than vehicle 10, control section 109 may determine that there is a possibility of the acceleration of vehicle 10 changing from positive acceleration to negative acceleration and turn on second switches 107a and 107b. In such a case, control section 109 inputs a signal representing to control vehicle 10 so as to avoid an interference object other than vehicle 10. For example, in the case of automatically avoiding an interference object using an in-vehicle camera imaging the front side of vehicle 10 or the like, vehicle 10 is automatically controlled so as to avoid an interference object other than vehicle 10.

### Control Example 2

### When Determination Parameters Include Stepping Amount of Accelerator of Vehicle 10

When the determination parameters include the stepping amount of an accelerator of vehicle 10, parameter acquiring section 110 acquires a signal representing the stepping amount of the accelerator and inputs the acquired signal to control section 109.

When the stepping amount of the accelerator is in a decreasing state, control section 109 determines that there is a possibility that electrical energy is stored in storage battery 106 in accordance with the generation of a regenerative braking force in electric motor 108 and turns on second switches 107a and 107b in preparation for the generation of the regenerative braking force. Here, when the accelerator enters a released state from a stepping state is included also in the decreasing state of the stepping amount of the accelerator.

The reason behind for including the state is that, when the stepping amount of the accelerator of vehicle 10 decreases, vehicle 10 is in a decelerating state, and accordingly, there is a possibility of generating a regenerative braking force in electric motor 108.

### Control Example 3

### When Determination Parameters Include Presence/Absence of Stepping on of Brake of Vehicle

When determination parameters include whether or not the brake of vehicle 10 is stepped on, parameter acquiring section 110 acquires a signal representing whether or not the brake is stepped on and inputs the acquired signal to control section 109.

When the brake is stepped on, control section 109 determines that there is a possibility that electrical energy is stored in storage battery 106 in accordance with the generation of a regenerative braking force in electric motor 108 and turns on second switches 107a and 107b in preparation for the generation of the regenerative braking force.

The reason for this is that, when the brake of vehicle 10 is stepped on, vehicle 10 is in a decelerating state, so that there is a possibility of generating a regenerative braking force in electric motor 108.

In addition, it is also possible to employ a configuration such that parameter acquiring section 110 further acquires a signal representing the speed of vehicle 10 as a determination parameter and inputs the acquired signal to control section 109, and control section 109 performs the above-described control process based on the stepping amount of the brake only in a case where the speed of vehicle 10 is at least a predetermined speed. The reason for this is that, in a case where the speed of vehicle 10 is less than a predetermined speed and slow, even when the brake is stepped on, the electrical energy outputted from electric motor 108 is low, so that there is no damage of elements provided between first switches 105a and 105b and electric motor 108.

### Control Example 4

### When Determination Parameters Include Whether Direction Indicator of Vehicle 10 is Operated

When the determination parameters include whether or not the direction indicator of vehicle 10 is operated is used, parameter acquiring section 110 acquires a signal representing whether or not the direction indicator is operated and inputs the acquired signal to control section 109.

When the direction indicator is operated to start indicating the direction, control section 109 determines that there is a possibility that electrical energy is stored in storage battery 106 in accordance with the generation of a regenerative braking force in electric motor 108 and turns on second switches 107a and 107b in preparation for the generation of the regenerative braking force.

The reason for this is that, when the direction indicator of vehicle 10 is operated to start indicating the direction, normally, there is a high possibility that vehicle 10 makes a left or right turn or changes the lane right after the operation, and there is a high possibility of decelerating vehicle 10, so that there is a possibility of generating a regenerative braking force in electric motor 108.

### Control Example 5

### When Determination Parameters Include Map Information of Periphery of Current Location of Vehicle 10

When the determination parameters include map information of the periphery of the current location of vehicle 10, parameter acquiring section 110 reads map information of the periphery of the current location of vehicle 10 from a storage section (not illustrated in the figure) storing the map information and inputs the read map information to control section 109. As the storage section storing the map information, for example, a car navigation apparatus installed in vehicle 10 may be used. In addition, the current location of vehicle 10, for example, may be acquired by using a GPS function of the car navigation apparatus.

Control section 109 determines that vehicle 10 is in a predetermined driving state based on the map information of the moving direction of vehicle 10 and turns on second switches 107a and 107b.

In other words, for example, based on the map information of the periphery of the current location of vehicle 10, when there is a downward slope (for example, a downward slope of three or more degrees) having a gradient larger than a predetermined angle in the moving direction of vehicle 10, control section 109 determines that vehicle 10 is later to be in the state of running on the downward slope, determines that there is a possibility that electrical energy is stored in storage battery 106 in accordance with the generation of a regenerative braking force in electric motor 108, and turns on second switches 107a and 107b in preparation for the generation of a regenerative braking force.

Here, the magnitude of the gradient may be represented in percentages. For example, a case may be represented as a gradient of one percent in which an altitude of 1 meter decreases as moving of 100 meters forward is made.

In addition, for example, a downward slope of a gradient larger than a predetermined angle is determined to continue for a predetermined distance or more (for example, 10 meters or more) in the moving direction of vehicle 10 based on the map information of the periphery of the current location of vehicle 10, control section 109 determines a state in which vehicle 10 travels on the downward slope for a predetermined distance or more, determines that there is a possibility that electrical energy is stored in storage battery 106 in accordance with the generation of a regenerative braking force in electric motor 108, and turns on second switches 107a and 107b in preparation for the generation of a regenerative braking force.

The reason for this is that, when there is a downward slope having a gradient larger than a predetermined angle in the moving direction of vehicle 10, or a downward slope having a gradient larger than a predetermined angle continues for a predetermined distance or more in the moving direction of vehicle 10, before vehicle 10 enters the downward slope, the stepping amount of the accelerator of vehicle 10 decreases or the stepping amount of the brake of vehicle 10 increases. Accordingly, there is a high possibility of decelerating vehicle 10, so that there is a possibility of generating a regenerative braking force in electric motor 108.

Control Examples 1 to 5 of control section 109 have been described above.

In addition, Control Examples 1 to 5 described above may be used in combination appropriately.

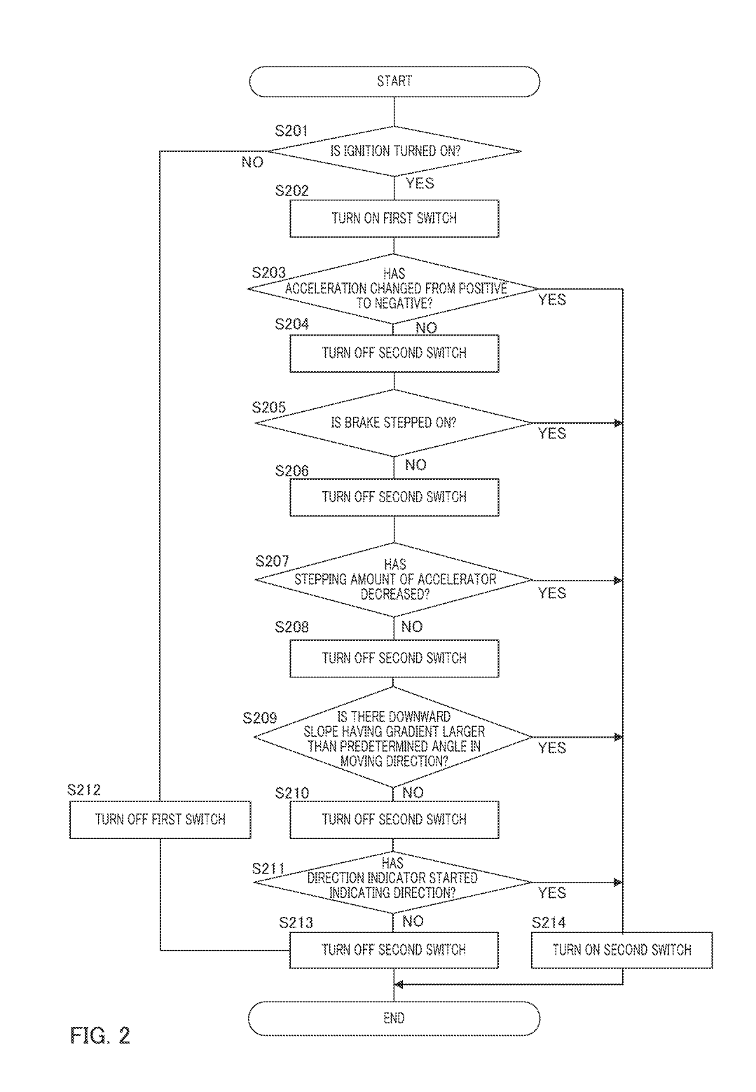

Hereinafter, an example of a case where all the Control Examples 1 to 5 are used in combination will be described. FIG. 2 is an operation flowchart of vehicle power supply apparatus 100 according to an embodiment of the present invention.

In S201 illustrated in FIG. 2, control section 109 determines whether or not the ignition of vehicle 10 is turned on. When the ignition is turned on (Yes in S201), control section 109 turns on first switches 105a and 105b (S202). On the other hand, when the ignition is not turned on (No in S201), control section 109 turns off first switches 105a and 105b and second switches 107a and 107b (S212 and S213).

In S203, the operation according to Control Example 1 described above is performed. In other words, when the acceleration of vehicle 10 changes from positive acceleration to negative acceleration (Yes in S203), control section 109 turns on the second switches 107a and 107b (S214). On the other hand, when the acceleration of vehicle 10 does not change from positive acceleration to negative acceleration (No in S203), control section 109 turns off second switches 107a and 107b (S204).

In S205, the operation according to Control Example 3 described above is performed. In other words, when the brake is stepped on (Yes in S205), control section 109 turns on second switches 107a and 107b (S214). On the other hand, when the brake is not stepped on (No in S205), control section 109 turns off the second switches 107a and 107b (S206).

In S207, the operation according to Control Example 2 described above is performed. In other words, when the stepping amount of the accelerator decreases (Yes in S207), control section 109 turns on second switches 107a and 107b (S214). On the other hand, when stepping amount of the accelerator does not decrease (No in S207), control section 109 turns off second switches 107a and 107b (S208).

In S209, the operation according to Control Example 5 described above is performed. In other words, when there is a downward slope having a gradient larger than a predetermined angle in the moving direction of vehicle 10 (Yes in S209), control section 109 turns on second switches 107a and 107b (S214). On the other hand, when there is no downward slope having a gradient larger than the predetermined angle in the moving direction of vehicle 10 (No in S209), control section 109 turns off second switches 107a and 107b (S210).

In S211, the operation according to Control Example 4 described above is performed. In other words, when the direction indicator is operated to start indicating the direction (Yes in S211), control section 109 turns on second switches 107a and 107b (S214). On the other hand, when the direction indicator is not operated to start indicating the direction (No in S211), control section 109 turns off second switches 107a and 107b (S213).

Then, the flow illustrated in FIG. 2 is repeated at a predetermined period (for example, an interval of 10 msec).

As above, in the case illustrated in FIG. 2, when one condition is satisfied in any one of Steps S203, S205, S207, S209, and S211, the control section 109 determines that there is a possibility that electrical energy is stored in storage battery 106 in accordance with the generation of a regenerative braking force in electric motor 108 and turns on second switches 107a and 107b in preparation for the generation of a regenerative braking force.

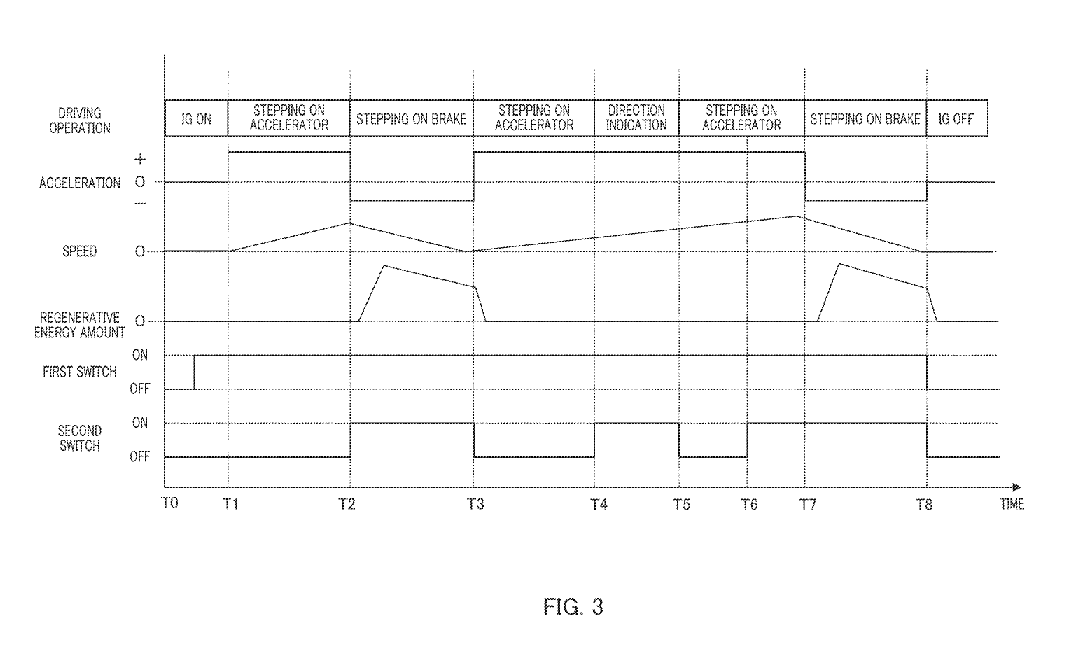

Next, the operation timing of vehicle power supply apparatus 100 that is based on an example of a driving state of vehicle 10 will be described. FIG. 3 is an operation timing diagram of the vehicle power supply apparatus 100 according to this embodiment.

As illustrated in FIG. 3, at time T0, the ignition is turned on (IG On), and accordingly, first switches 105a and 105b are turned on.

When the accelerator is stepped on at time T1, the acceleration of vehicle 10 becomes positive acceleration in accordance with an increase in the speed of vehicle 10. Accordingly, second switches 107a and 107b are maintained to be in the turned-off state. The reason for this is that there is no possibility of generating a regenerative braking force when the acceleration of vehicle 10 is positive acceleration.

When the brake is stepped on at time T2, the acceleration of the vehicle becomes negative acceleration so as to decrease the speed of vehicle 10, so that there is a possibility of generating a regenerative braking force during time T2 to time T3. Therefore, at time T2, second switches 107a and 107b are turned on in preparation for the generation of a regenerative braking force.

When the accelerator is stepped on again at time T3, the acceleration of vehicle 10 becomes positive acceleration, and accordingly, the second switches 107a and 107b are turned off.

When the direction indicator is operated to start indicating the direction at time T4, second switches 107a and 107b are turned on even in the state in which the accelerator is stepped on.

At time T5, when the indicating of the direction performed by the direction indicator ends, second switches 107a and 107b are turned off. In addition, when the accelerator is stepped on again at time T5, second switches 107a and 107b are kept in the turned-off state.

At time T6, in a case where it is determined that there is a downward slope having a gradient of an angle larger than a predetermined angle in the moving direction of vehicle 10, even when the acceleration of vehicle 10 is positive acceleration, second switches 107a and 107b are turned on.

At time T7, when the brake is stepped on, continuously, second switches 107a and 107b are kept in the turned-on state.

Then, at time T8, when vehicle 10 is stopped, and the ignition is turned off (IG Off), first switches 105a and 105b are turned off, and second switches 107a and 107b are turned off.

### Embodiment 2

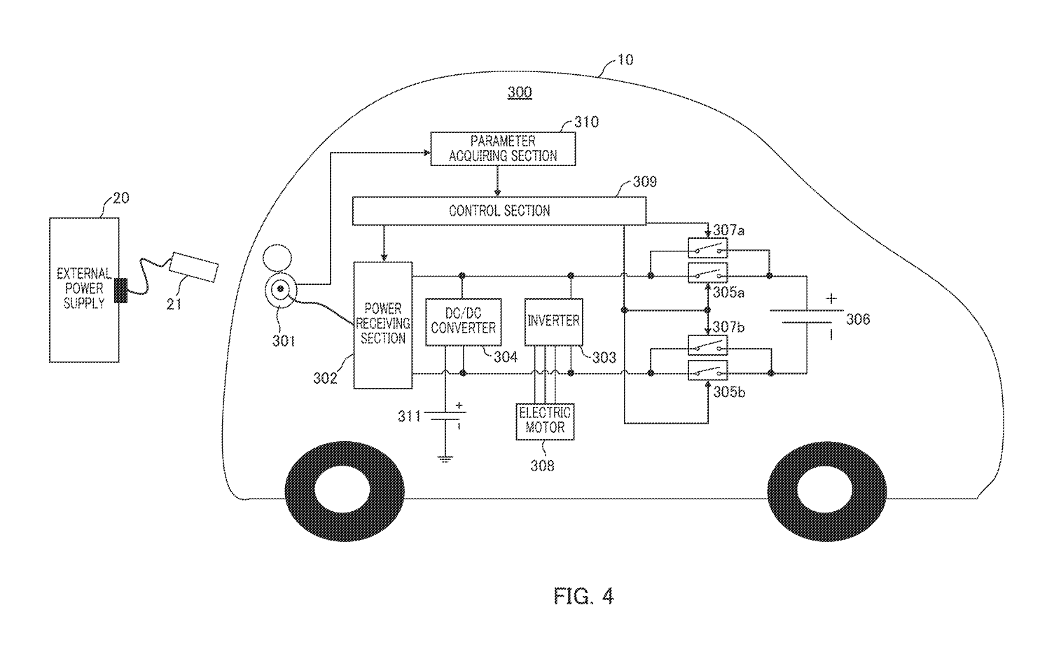

FIG. 4 is a block diagram illustrating the configuration of vehicle power supply apparatus 300 according to Embodiment 2 of the present invention.

As illustrated in FIG. 4, vehicle power supply apparatus 300 is installed in vehicle 10. Vehicle power supply apparatus 300 includes: lid section 301; power receiving section 302; inverter 303, DC/DC converter 304; first switches 305a and 305b; second switches 307a and 307b; storage battery 306; electric motor 308; control section 309; parameter acquiring section 310; and an auxiliary battery 311. Here, storage battery 306 and first switches 305a and 305b correspond to a battery and a relay of the vehicle power supply apparatus of the related art (PTL 1) described above.

Hereinafter, the operation at the time of charging storage battery 306 and the operation at the time of discharging storage battery 306 will be separately described.

First, the operation at the time of charging storage battery 306 will be described.

<Operation at Time of Charging Storage Battery 306>

In vehicle power supply apparatus 300, power supply plug 21 is inserted from the outside of vehicle 10 into electrodes provided in lid section 301, and accordingly, electrical energy can be supplied from external power supply 20 and be stored in storage battery 306.

External power supply 20 is a power supply disposed outside vehicle 10 and includes power supply plug 21. In a case where external power supply 20 is a household power supply, for example, AC electrical energy of about 100 to 240 V is supplied from external power supply 20. On the other hand, in a case where external power supply 20 is a charging station, for example, DC electrical energy of about 400 V is supplied from external power supply 20.

Lid section 301 can be attached/detached or opened/closed by a user of vehicle 10. The user of vehicle 10 starts charging by inserting power supply plug 21 into lid section 301 from the outside of the vehicle 10. Lid section 301 is provided with electrodes. When power supply plug 21 is inserted, electrodes of power supply plug 21 and the electrodes of lid section 301 are brought into contact with each other, and accordingly, electrical energy can be supplied from external power supply 20 to vehicle 10. When the electrodes of power supply plug 21 and the electrodes of lid section 301 are in the state of being brought into contact with each other, lid section 301 outputs a signal representing an indication thereof to parameter acquiring section 310.

Power receiving section 302 receives electrical energy supplied through the electrodes arranged in lid section 301 and outputs the electrical energy under the control of control section 309. When AC electrical energy is supplied from external power supply 20, power receiving section 302 converts the AC electrical energy into DC electrical energy and outputs the converted DC electrical energy under the control of control section 309. On the other hand, when DC electrical energy is supplied from external power supply 20, power receiving section 302 outputs the DC electrical energy under the control of control section 309. The DC electrical energy outputted from power receiving section 302 is stored in storage battery 306 through first switches 305a and 305b and second switches 307a and 307b. In addition, the DC electrical energy outputted from power receiving section 302 is stored in auxiliary battery 311 through DC/DC converter 304.

DC/DC converter 304 performs voltage transformation of the DC electrical energy outputted by power receiving section 302. The transformed electrical energy is outputted to be stored in auxiliary battery 311.

A shaft of electric motor 308 is connected to a vehicle shaft of drive wheels of vehicle 10 and generates a regenerative braking force by converting the kinetic energy of vehicle 10 into electrical energy. When a rotor provided in electric motor 308 is rotated by an external force (a rotation force of the vehicle shaft of drive wheels of vehicle 10), electric motor 308 serves as a power generator so as to generate electrical energy. Accordingly, when the kinetic energy according to the rotation of the vehicle shaft is converted into electrical energy, a regenerative braking force, which is a resistance force against the rotation of the vehicle shaft, is generated. Electric motor 308 outputs this electrical energy to inverter 303. This electrical energy is AC electrical energy.

Inverter 303 converts AC electrical energy outputted by electric motor 308 into DC electrical energy and outputs the converted DC electrical energy. The converted DC electrical energy is stored in storage battery 306 through first switches 305a and 305b and second switches 307a and 307b.

When turned on by control section 309, first switches 305a and 305b electrically connect power receiving section 302 and storage battery 306 and electrically connect electric motor 308 and storage battery 306. On the other hand, when turned off by control section 309, first switches 305a and 305b electrically disconnect power receiving section 302 and storage battery 306 from each other and electrically disconnect electric motor 308 and storage battery 306 from each other. For example, each one of first switches 305a and 305b is a mechanical switch including a movable contact and fixed contacts in which the fixed contacts become conductive (turned on) or non-conductive (turned off) by moving the movable contact.

Second switches 307a and 307b are electrically connected in parallel with first switches 305a and 305b. When turned on by control section 309, second switches 307a and 307b electrically connect power receiving section 302 and storage battery 306 and electrically connect electric motor 308 and storage battery 306. In addition, when turned off by control section 309, second switches 307a and 307b electrically disconnect power receiving section 302 and storage battery 306 from each other and electrically disconnect electric motor 308 and storage battery 306 from each other. For example, second switches 307a and 307b, similarly to first switches 305a and 305b, are mechanical switches. Second switches 307a and 307b, as will be described later, are used for preventing elements (for example, inverter 303 and DC/DC converter 304) provided between power receiving section 302 and first switches 305a and 305b from being damaged due to the electrical energy supplied from the external power supply 20.

First switch 305a and second switch 307a are arranged on the positive electrode side of storage battery 306. In addition, first switch 305b and second switch 307b are arranged on the negative electrode side of storage battery 306.

Here, it is preferable that the on-resistance values of first switches 305a and 305b be smaller than the on-resistance values of second switches 307a and 307b. Accordingly, the current flowing through second switches 307a and 307b is smaller than the current flowing through first switches 305a and 305b, whereby the stress applied to second switches 307a and 307b due to the currents decreases. Accordingly, deterioration of second switches 307a and 307b can be suppressed.

Storage battery 306 stores DC electrical energy outputted by power receiving section 302 and DC electrical energy outputted by inverter 303. As storage battery 306, a secondary battery (such as a nickel hydride rechargeable battery or a lithium ion rechargeable battery) having a high energy density or a high-capacity capacitor is used.

Control section 309 controls On/Off of first switches 305a and 305b and second switches 307a and 307b based on various parameters inputted from parameter acquiring section 310. Control section 309 is configured by a CPU, a ROM, a RAM, and the like. The CPU executes a program stored in the ROM, the RAM, or the like, thereby performing various calculations, output of control signals, and the like. The control process performed by control section 309 will be described later in detail.

Parameter acquiring section 310 acquires various parameters necessary for the control process performed by control section 309 and outputs the acquired parameters to control section 309.

Next, the operation at the time of discharging storage battery 306 will be described.

<Operation at Time of Discharging Storage Battery 306>

The electrical energy stored in storage battery 306, for example, is used as power for operating electric motor 308 as a power supply for driving the drive wheels of vehicle 10. When electric motor 308 is used as a motor, inverter 303 converts DC electrical energy stored in storage battery 306 into AC electrical energy and outputs the converted AC electrical energy to electric motor 308. The shaft of electric motor 308 is connected to the vehicle shaft of the drive wheels of vehicle 10, and the drive wheels of vehicle 10 rotate in accordance with the rotation of the shaft.

In addition, the electrical energy stored in storage battery 306 is used as power for operating, for example, accessory apparatuses such as a car navigation apparatus and a car audio and electric components such as a power window, an ETC (registered trademark), and an electronic control unit (ECU) through DC/DC converter 304. In addition, the electrical energy stored in storage battery 306 is stored in auxiliary battery 311 through DC/DC converter 304. In such cases, DC/DC converter 304 performs voltage transformation of the DC electrical energy outputted from storage battery 306.

As above, the operations at the time of charging and discharging storage battery 306 have been described.

Next, the control process of power receiving section 302, first switches 305a and 305b, and second switches 307a and 307b, which is performed by control section 309, will be described.

When electrical energy by the generation of a regenerative braking force in electric motor 308 is stored in storage battery 306, control section 309 turns on first switches 305a and 305b and the second switches 307a and 307b.

On the other hand, when electrical energy supplied from external power supply 20 is stored in storage battery 306, control section 309, when the state of vehicle 10 is a predetermined state in which the electrical energy may be stored in storage battery 306, turns on first switches 305a and 305b and second switches 307a and 307b and then outputs the electrical energy from power receiving section 302. As described above, after first switches 305a and 305b and second switches 307a and 307b are turned on, power receiving section 302 outputs the received electrical energy in accordance with an output instruction from control section 309. In addition, control section 309 determines whether or not the state of vehicle 10 is the predetermined state in which the electrical energy may be stored in storage battery 306 based on a signal and various parameters inputted from parameter acquiring section 310.

Control section 309 determines whether or not the state is the predetermined state in which the electrical energy may be stored in storage battery 306 as below. Then, control section 309 turns on first switches 305a and 305b and second switches 307a and 307b in advance in preparation for the supply of electrical energy to storage battery 306 and outputs the electrical energy from power receiving section 302 after the turn-on times of first switches 305a and 305b and second switches 307a and 307b sufficiently elapse. In this manner, first switches 305a and 305b and second switches 307a and 307b can be surely electrically connected until a time point when the electrical energy is outputted from power receiving section 302. Therefore, according to this embodiment, the elements (for example, inverter 303 and DC/DC converter 304) provided between power receiving section 302 and first switches 305a and 305b can be prevented from being damaged due to the electrical energy supplied from external power supply 20.

In other words, according to this embodiment, even in a case where first switches 305a and 305b are non-conductive due to breakdown or the like at the time of supplying electrical energy from external power supply 20, the electrical energy outputted from power receiving section 302 can be surely stored in storage battery 306 through second switches 307a and 307b. Accordingly, damages in elements provided between power receiving section 302 and first switches 305a and 305b can be prevented.

Here, the predetermined state of vehicle 10 in which the electrical energy may be stored in storage battery 306 represents (1) a state in which storage battery 306 is chargeable and (2) a state in which there is an indication of charging storage battery 306.

Hereinafter, (1) the state in which storage battery 306 is chargeable and (2) the state in which there is an indication of charging storage battery 306 will be described with reference to examples.

First, examples of the state in which storage battery 306 is chargeable will be described below.

(1) Examples of State in Which Storage Battery 306 is Chargeable

### Example 1-1

When vehicle 10 is in a parked state. In this case, parameter acquiring section 310 acquires, for example, a signal representing that the parking brake of vehicle 10 is applied as a determination parameter and outputs the acquired signal to control section 309, and control section 309 determines whether or not vehicle 10 is in the parked state based on whether or not the signal is inputted.

### Example 1-2

When vehicle 10 is in a state in which state of charge (SOC) of storage battery 306 is less than a threshold. In this case, parameter acquiring section 310 acquires a signal representing the state of charge of storage battery 306 as a determination parameter and outputs the acquired signal to control section 309. Control section 309 determines whether or not the state of charge of storage battery 306 is in a state being less than a threshold based on the signal.

### Example 1-3

When electrodes of power supply plug 21 and electrode of lid section 301 are in state of being in contact with each other, i.e., power receiving section 302 and external power supply 20 are in state of being electrically connected to each other. In this case, parameter acquiring section 310 acquires a signal (a signal representing that the electrode of power supply plug 21 and the electrode of lid section 301 are in a state of being in contact with each other) inputted from lid section 301 and outputs the acquired signal to control section 309, and control section 309 determines whether or not the electrodes of power supply plug 21 and the electrodes of lid section 301 are in the state of being in contact with each other based on whether or not the signal is inputted.

### Example 1-4

When external power supply 20 is in state of being capable of supplying electrical energy (e.g., when external power supply 20 is not broken). In this case, both external power supply 20 and parameter acquiring section 310 have communication functions, and parameter acquiring section 310 acquires a signal representing that external power supply 20 can supply electrical energy through communication with external power supply 20 and outputs the acquired signal to control section 309, and control section 309 determines whether or not external power supply 20 is in the state of being capable of supplying the electrical energy based on whether or not the signal is inputted.

### Example 1-5

When there is no problem according to safety checking of electric leakage and the like. In external power supply 20 or power receiving section 302, generally, an earth leakage breaker is included. Accordingly, in this case, parameter acquiring section 310 acquires a signal representing that there is no electrical leakage from external power supply 20 or power receiving section 302 and outputs the acquired signal to control section 309, and control section 309 determines whether or not vehicle 10 is in the safe state based on whether or not the signal is inputted. In addition, when external power supply 20 includes an earth leakage breaker, both external power supply 20 and parameter acquiring section 310 have communication functions, and parameter acquiring section 310 acquires the above-described signal through communication with external power supply 20.

The examples of the state in which storage battery 306 is chargeable have been described above.

Next, examples of the state in which there is an indication of charging storage battery 306 will be described below.

(2) Examples of State in Which There is Indication of Charging Storage Battery 306

### Example 2-1

When vehicle 10 is in a state in which user of vehicle 10 turns on charge starting switch. In this case, parameter acquiring section 310 acquires a signal representing that the charge starting switch is turned on as a determination parameter and outputs the acquired signal to control section 309, and control section 309 determines whether or not the charge starting switch is turned on based on whether or not the signal is inputted. The charge starting switch may be included in either vehicle 10 or external power supply 20. In addition, the charge starting switch may be either a mechanical switch or a software switch displayed on a screen. When external power supply 20 includes the charge starting switch, both external power supply 20 and parameter acquiring section 310 have communication functions, and parameter acquiring section 310 acquires the above-described signal through communication with external power supply 20.

### Example 2-2

When vehicle 10 is in a state in which it is charge starting time set in timer in advance. In this case, parameter acquiring section 310 acquires a signal representing that it is the charge starting time as a determination parameter and outputs the acquired signal to control section 309, and control section 309 determines whether or not it is a state in which the charge starting time has come based on whether or not the signal is inputted. A timer may be included in either vehicle 10 or external power supply 20. When external power supply 20 includes the timer, both external power supply 20 and parameter acquiring section 310 have communication functions, and parameter acquiring section 310 acquires the above-described signal through communication with external power supply 20.

### Example 2-3

When vehicle 10 is in a state in which receiving of electrical energy using power receiving section 302 is started. In this case, control section 309 monitors the power reception state of power receiving section 302 and determines whether or not reception of electrical energy is started by power receiving section 302.

The examples of the state in which there is an indication for charging storage battery 306 have been described above.

In addition, Examples 1-1 to 1-5 and Examples 2-1 to 2-3 described above may be used in combination, appropriately. For example, when vehicle 10 is in all the states of Examples 1-1 to 1-5 and is in any one state of Examples 2-1 to 2-3, control section 309 may determine that vehicle 10 is in the predetermined state in which electrical energy can be stored in storage battery 106.

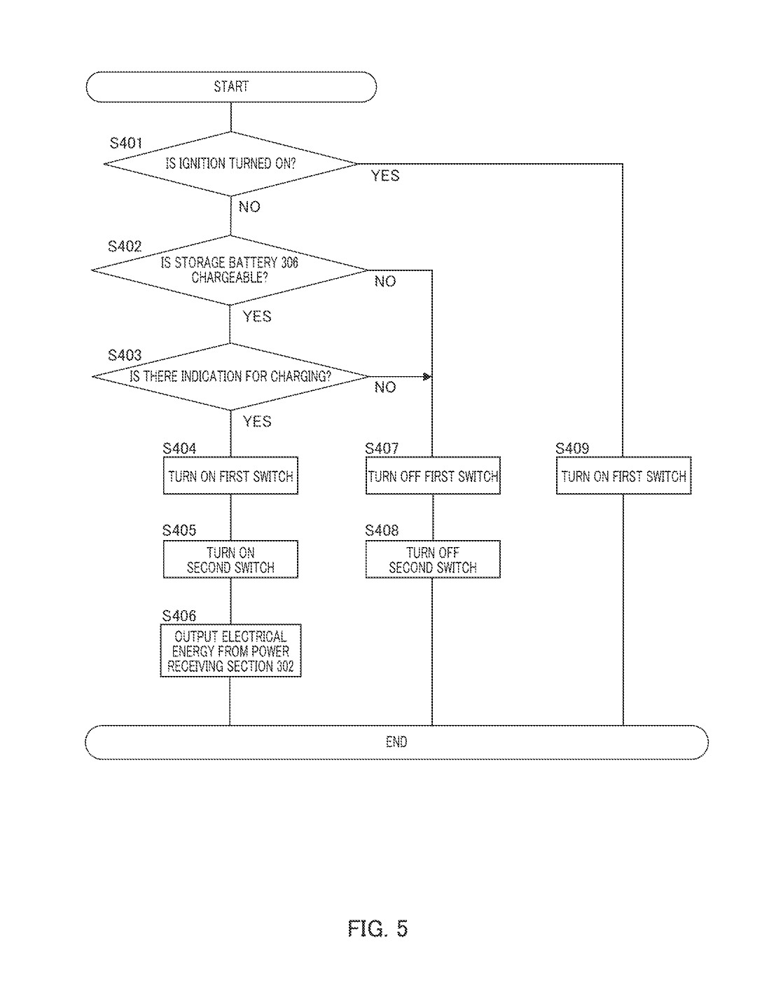

Next, the operation flow of vehicle power supply apparatus 300 according to this embodiment will be described with reference to FIG. 5.

In S401 illustrated in FIG. 5, parameter acquiring section 310 acquires a signal representing that the ignition of vehicle 10 is turned on by an ignition key and outputs the acquired signal to control section 309. Control section 309 determines whether or not the ignition of vehicle 10 is turned on based on whether this signal has been inputted. Here, instead of turning-on of the ignition using the ignition key, a signal representing the turning-on of the ignition using a push-type start button or a key using radio waves may be used.

When the ignition is turned on (Yes in S401), control section 309 turns on first switches 305a and 305b (S409). The reason for this is that, when the ignition is turned on, it is necessary to electrically connect storage battery 306 to each section so as to allow vehicle 10 to run.

On the other hand, when the ignition is not turned on (No in S401), control section 309 determines whether or not the vehicle is in a state in which storage battery 306 is chargeable (S402).

When the vehicle is not in the state in which storage battery 306 is chargeable (No in S402), control section 309 turns off first switches 305a and 305b (S407) and turns off second switches 307a and 307b (S408).

On the other hand, when the vehicle is in the state in which storage battery 306 is chargeable (Yes in S402), control section 309 determines whether there is an indication for charging (S403).

In the case of a state in which there is no indication for charging (No in S403), control section 309 turns off first switches 305a and 305b (S407) and turns off second switches 307a and 307b (S408).

As above, the reason for control section 309 to turn off first switches 305a and 305b and second switches 307a and 307b when the vehicle is not in the state in which storage battery 306 is chargeable or the state in which there is no indication for charging is that, vehicle 10 is not in the predetermined state in which electrical energy may be stored in storage battery 306 in such a case, and control section 309 does not output the electrical energy from power receiving section 302.

On the other hand, in the case of a state in which there is an indication for charging (Yes in S403), control section 309 turns on first switches 305a and 305b (S404) and turns on second switches 307a and 307b (S405), and then outputs electrical energy from power receiving section 302 (S406).

Then, the above-described flow illustrated in FIG. 5 is repeatedly performed for a predetermined period (for example, an interval of 100 msec).

As above, as illustrated in FIG. 5, when the vehicle is in the state in which storage battery 306 is chargeable and there is an indication for charging, in other words, vehicle 10 is in the predetermined state in which the electrical energy may be stored in storage battery 306, control section 309 turns on first switches 305a and 305b and second switches 307a and 307b, and then outputs the electrical energy from power receiving section 302.

Here, in the case illustrated in FIG. 5, the processing sequence of S402 and S403 may be reversed as long as it is prior to S406. In addition, the processing sequence of S404 and S405 may be reversed as long as it is prior to S406. Furthermore, the processing sequence of S407 and S408 may be reversed.

Here, from the viewpoint of safety, it is preferable that first switches 305a and 305b and second switches 307a and 307b be turned off when they are not necessary. Thus, according to this embodiment, as described above, at a time point when the vehicle is not only in the state in which storage battery 306 is chargeable but also in the state in which there is an indication for charging storage battery 306, first switches 305a and 305b and second switches 307a and 307b are turned on, and, after first switches 305a and 305b and second switches 307a and 307b are turned on, outputting the electrical energy from power receiving section 302 is started. Therefore, according to this embodiment, damages in elements due to the electrical energy supplied from external power supply 20 to vehicle 10 can be prevented.

### Embodiment 3

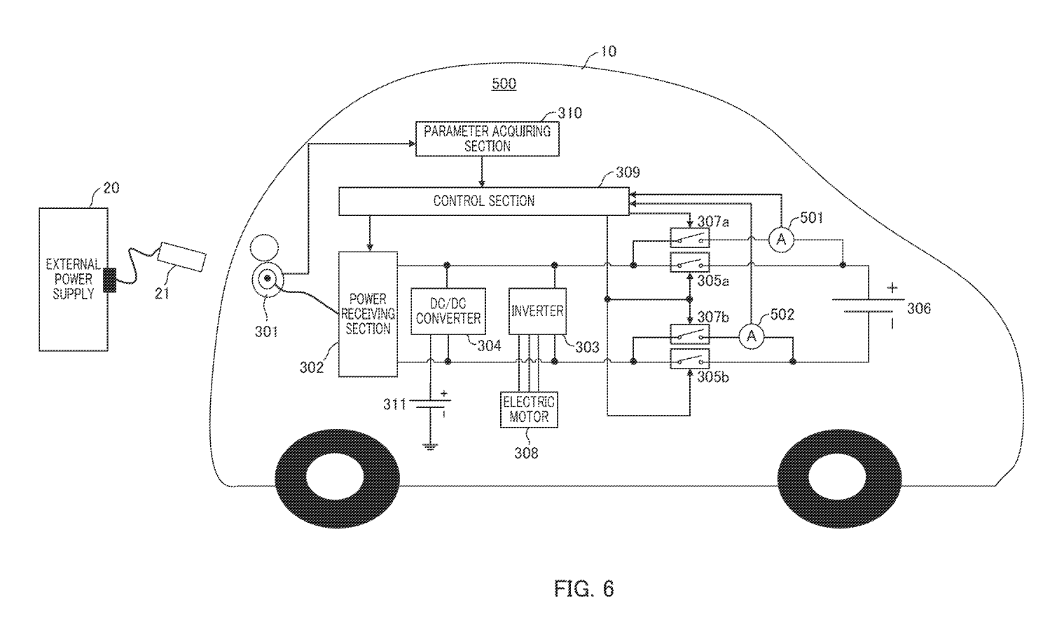

FIG. 6 is a block diagram illustrating the configuration of vehicle power supply apparatus 300 according to Embodiment 3 of the present invention. In FIG. 6, the same reference numerals are assigned to the same components as those illustrated in FIG. 4 (Embodiment 2), and any redundant description thereof will be omitted. In this embodiment, vehicle power supply apparatus 300 further includes ammeters 501 and 502, which is different from Embodiment 2. Hereinafter, only differences from Embodiment 2 will be described.

In vehicle power supply apparatus 300 illustrated in FIG. 6, ammeter 501 measures the magnitude of a current flowing through second switch 307a and outputs a measured value to control section 309. In addition, ammeter 502 measures the magnitude of a current flowing through second switch 307b and outputs a measured value to the control section 309.

As described in Embodiment 2, control section 309 turns on first switches 305a and 305b and second switches 307a and 307b and then outputs electrical energy from power receiving section 302. In addition, after the electrical energy is outputted from power receiving section 302, when the measured value by ammeter 501 (the magnitude of the current flowing through second switch 307a) or the measured value by ammeter 502 (the magnitude of the current flowing through second switch 307b) is a predetermined threshold or more, control section 309 determines that first switch 305a or 305b is non-conductive due to breakdown or the like, and stops outputting the electrical energy from power receiving section 302.

Here, in vehicle power supply apparatus 300, instead of ammeter 501 or 502, a voltmeter may be used which measures the magnitude of a voltage between terminals of second switch 307a or 307b and outputs a measured value to control section 309. In such a case, after the electrical energy is outputted from power receiving section 302, when the magnitude of the voltage between the terminals of second switch 307a is a predetermined threshold or more, control section 309 determines that first switch 305a is non-conductive due to breakdown or the like and stops outputting the electrical energy from power receiving section 302.

As above, according to this embodiment, when first switch 305a or 305b is determined to be non-conductive due to breakdown or the like, the output of electrical energy from power receiving section 302 is stopped, and accordingly, before second switch 307a or 307b becomes non-conductive due to breakdown or the like, elements provided between power receiving section 302 and first switches 305a and 305b can be prevented from being damaged.

In addition, after the output of the electrical energy from power receiving section 302 is stopped as described above, when the magnitude of the current flowing through second switch 307a or 307b, or the magnitude of the voltage between the terminals of second switch 307a or 307b is less than a predetermined threshold, the control section 309 may turn off second switch 307a or 307b. In this manner, the charging of storage battery 306 can be completed without damaging elements provided between electric motor 308 and first switches 305a and 305b.

### Embodiment 4

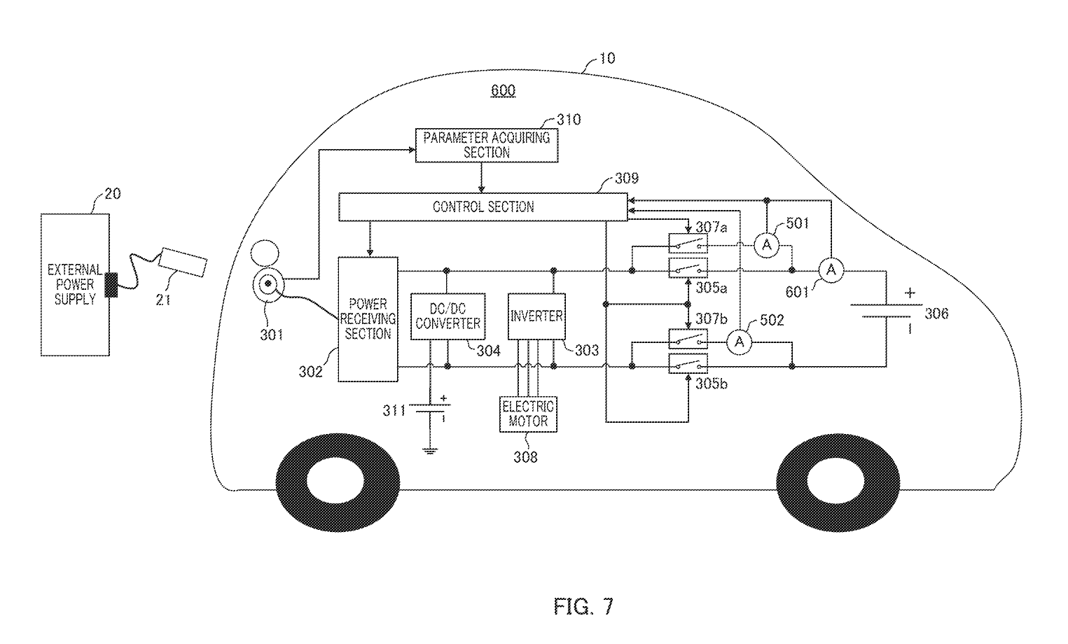

FIG. 7 is a block diagram illustrating the configuration of vehicle power supply apparatus 600 according to Embodiment 4 of the present invention. In FIG. 7, the same reference numerals are assigned to the same components as those illustrated in FIG. 4 (Embodiment 2) or FIG. 5 (Embodiment 3), and any redundant description thereof will be omitted. In this embodiment, vehicle power supply apparatus 600 further includes ammeter 601, which is different from Embodiment 3. Hereinafter, only differences from Embodiments 2 and 3 will be described.

In vehicle power supply apparatus 600 illustrated in FIG. 7, ammeter 601 measures a sum of the magnitude of a current flowing through first switch 305a and the magnitude of a current flowing through second switch 307a, that is, the magnitude of a current flowing through storage battery 306, and outputs a measured value to control section 309.

As described in Embodiment 2, control section 309 turns on first switches 305a and 305b and second switches 307a and 307b and then outputs electrical energy from power receiving section 302. In addition, after the electrical energy is outputted from power receiving section 302, in a case where the measured value by ammeter 501 (the magnitude of the current flowing through second switch 307a) or the measured value by ammeter 502 (the magnitude of the current flowing through second switch 307b) is approximately the same as the measure value by ammeter 601 (the magnitude of the current flowing through storage battery 306), control section 309 determines that first switch 305a or 305b is non-conductive due to breakdown or the like, and stops outputting the electrical energy from power receiving section 302.

As above, according to this embodiment, similarly to Embodiment 2, in a case where first switch 305a or 305b is determined to be non-conductive due to breakdown or the like, the output of electrical energy from power receiving section 302 is stopped. Accordingly, before second switch 307a or 307b becomes non-conductive due to breakdown or the like, elements provided between power receiving section 302 and first switches 305a and 305b can be prevented from being damaged.

In addition, according to this embodiment, even when the current flowing through second switch 307a or 307b is low, the breakdown of first switch 305a or 305b is detected, and the output of the electrical energy from power receiving section 302 can be stopped, and accordingly, the charging of storage battery 306 can be completed while elements provided between power receiving section 302 and first switches 305a and 305b are prevented from being damaged. Furthermore, according to this embodiment, in a case where the measured values ammeters 501 and 502 are almost the same as zero while a current flows through ammeter 601, the breakdown of second switch 307a or 307b can be detected.

As above, the embodiments of the present invention have been described.

In addition, in the above-described embodiments, while first switches 105a and 105b (305a and 305b) and second switches 107a and 107b (307a and 307b) have been described as mechanical switches, the present invention is not limited thereto. Thus, first switches 105a and 105b (305a and 305b) and second switches 107a and 107b (307a and 307b) may be switches using semiconductors having no contact.

Furthermore, in the above-described embodiments, in order to improve the safety, while a configuration has been described in which first switches 105a and 105b (305a and 305b) and second switches 107a and 107b (307a and 307b) are provided on both of the positive electrode side of storage battery 106 (306) and the negative electrode side of storage battery 106 (306), the present invention is not limited thereto. Thus, first switches 105a and 105b (305a and 305b) and second switches 107a and 107b (307a and 307b) may be provided on only one of the positive electrode side and the negative electrode side of storage battery 106 (306). The reason for this is that it is sufficient to electrically cut off any one of the positive electrode side and the negative electrode side of storage battery 106 (306) for stopping the power supply of storage battery 106 (306).

In addition, in the above-described embodiments, the use of household power supply is assumed, and the configuration of a case where electrical energy, supplied from the power supply plug through the electrodes provided in lid section 101, is AC has been described. For example, DV electrical energy of about 400 V is supplied from the power supply plug connected to a charging station. Accordingly, in a case where charging using the charging station is considered, charger 102 converting AC electrical energy into DC electrical energy can be provided in the charging station, and accordingly, vehicle power supply apparatus 100 does not need to include charger 102. In addition, the transmission/reception of electrical energy between the household power or the charging station and charger 102 may be performed through non-contact charging using electromagnetic induction.

Although the above-noted embodiments have been described by examples of hardware implementations, the present invention can also be implemented by software in conjunction with hardware.

The functional blocks used in the descriptions of the above-noted embodiments are typically implemented by LSI devices, which are integrated circuits. These may be individually implemented as single chips and, alternatively, a part or all thereof may be implemented as a single chip. The term LSI devices as used herein, depending upon the level of integration, may refer variously to ICs, system LSI devices, very large-scale integrated devices, and ultra-LSI devices.

The method of integrated circuit implementation is not restricted to LSI devices, and implementation may be done by dedicated circuitry or a general-purpose processor. After fabrication of an LSI device, a programmable FPGA (field-programmable gate array) or a re-configurable processor that enables reconfiguration of connections of circuit cells within the LSI device or settings thereof may be used.

Additionally, in the event of the appearance of technology for integrated circuit implementation that replaces LSI technology by advancements in semiconductor technology or technologies derivative therefrom, that technology may of course be used to integrate the functional blocks. Another possibility is the application of biotechnology or the like.

The disclosures of Japanese Patent Application Nos. 2011-072267 and 2011-077919, filed on Mar. 29, 2011 and Mar. 31, 2011, including the specifications, drawings and abstracts, are incorporated herein by reference in their entirety.

### INDUSTRIAL APPLICABILITY

The present invention is suitable for a vehicle power supply apparatus provided to a vehicle driven by electrical energy stored in a storage battery.

### Reference Signs List

10 Vehicle

100, 300, 500, 600 Vehicle power supply apparatus

101, 301 Lid section

102, 302 Charger

103, 303 Inverter

104, 304 DC/DC converter

105a, 105b, 305a, 305b First switch

106, 306 Storage battery

107a, 107b, 307a, 307b Second switch

108, 308 Electric motor

109, 309 Control section

110, 310 Parameter acquiring section

111, 311 Auxiliary battery

501, 502, 601 Ammeter

1-20. (canceled)

21. A vehicle power supply apparatus to be installed to a vehicle, the apparatus comprising:
an electric motor that generates a regenerative braking force by converting kinetic energy into electrical energy;
a storage battery that stores the electrical energy;
a first switch that electrically connects the electric motor and the storage battery to each other;
a second switch that is connected in parallel with the first switch and electrically connects the electric motor and the storage battery to each other; and
a control section that controls the first switch and the second switch, wherein
the control section performs control for turning on the first switch and turns on the second switch when the vehicle is in a predetermined state having a possibility that the electrical energy is stored in the storage battery in accordance with generation of a regenerative braking force or when the vehicle is operated to perform a predetermined operation having the possibility.

22. The vehicle power supply apparatus according to claim 21, wherein an on-resistance value of the first switch is smaller than an on-resistance value of the second switch.

23. The vehicle power supply apparatus according to claim 21, wherein, when acceleration of the vehicle is in a state of changing from positive acceleration to negative acceleration, the control section determines that the vehicle is in the predetermined state having the possibility, and the control section thus turns on the second switch.

24. The vehicle power supply apparatus according to claim 23, wherein, when the vehicle is controlled so as to keep a predetermined speed, the control section determines that there is a possibility that the acceleration changes from the positive acceleration to the negative acceleration, and the control section thus turns on the second switch.

25. The vehicle power supply apparatus according to claim 23, wherein, when the vehicle is controlled so as to avoid an interference object other than the vehicle, the control section determines that there is a possibility that the acceleration changes from the positive acceleration to the negative acceleration, and the control section thus turns on the second switch.

26. The vehicle power supply apparatus according to claim 21, wherein, when a stepping amount of an accelerator of the vehicle is in a decreasing state, the control section determines that the vehicle is in the predetermined state having the possibility, and the control section thus turns on the second switch.

27. The vehicle power supply apparatus according to claim 21, wherein, when the vehicle is in a state in which a brake of the vehicle is stepped on, the control section determines that the vehicle is in the predetermined state having the possibility, and the control section thus turns on the second switch.

28. The vehicle power supply apparatus according to claim 21, wherein, when a direction indicator of the vehicle is operated to start indicating a direction, the control section determines that the vehicle performs the predetermined operation having the possibility, and the control section thus turns on the second switch.

29. The vehicle power supply apparatus according to claim 21, wherein the control section determines that the vehicle is in the predetermined state based on map information of a moving direction of the vehicle.

30. The vehicle power supply apparatus according to claim 29, wherein, when determining that the vehicle is later to be in a state of running on a downward slope having a gradient larger than a predetermined angle based on the map information, the control section determines that the vehicle is in the predetermined state having the possibility, and the control section thus turns on the second switch.

31. The vehicle power supply apparatus according to claim 29, wherein, when determining that the vehicle is later to be in a state of running on a downward slope having a gradient larger than a predetermined angle for a predetermined distance or more based on the map information, the control section determines the vehicle is in the predetermined state having the possibility, and the control section thus turns on the second switch.

32. A vehicle power supply apparatus to be installed in a vehicle, the apparatus comprising:
a power receiving section that receives electrical energy supplied from a power supply disposed outside the vehicle;
a storage battery that stores the electrical energy outputted from the power receiving section;
a first switch that electrically connects the power receiving section and the storage battery to each other;
a second switch that is connected in parallel with the first switch and electrically connects the power receiving section and the storage battery to each other; and
a control section that controls the power receiving section, the first switch, and the second switch, wherein
the control section turns on the first switch and the second switch and then outputs the electrical energy from the power receiving section when the state of the vehicle is a state in which the storage battery is chargeable and a state in which there is an indication for charging the storage battery.

33. The vehicle power supply apparatus according to claim 32, wherein the state in which the storage battery is chargeable is at least one of: state in which the vehicle is parked; a state in which a state of charge of the storage battery is less than a threshold; a state in which the power receiving section is electrically connected to the power supply disposed outside the vehicle; and a state in which the power supply disposed outside the vehicle can supply electrical energy.

34. The vehicle power supply apparatus according to claim 32, wherein the state in which there is an indication is at least one of: a state in which a charge starting switch included in the vehicle is turned on; a state in which a timer included in the vehicle indicates predetermined time; and a state in which electrical energy is started to be received by the power receiving section.

35. The vehicle power supply apparatus according to claim 32, wherein an on-resistance value of the first switch is smaller than an on-resistance value of the second switch.

36. The vehicle power supply apparatus according to claim 32, wherein the control section stops outputting of the electrical energy from the power receiving section when the magnitude of a current flowing through the second switch is a predetermined threshold or greater.

37. The vehicle power supply apparatus according to claim 35, wherein, the control section turns off the second switch when the magnitude of the current becomes less than the predetermined threshold, after stopping outputting of the electrical energy from the power receiving section.

38. The vehicle power supply apparatus according to claim 32, wherein the control section stops outputting of the electrical energy from the power receiving section when the magnitude of a voltage between terminals of the second switch is a predetermined threshold or greater.

39. The vehicle power supply apparatus according to claim 37, wherein the control section turns off the second switch when the magnitude of the voltage between the terminals becomes less than the predetermined threshold, after stopping outputting of the electrical energy from the power receiving section.

40. The vehicle power supply apparatus according to claim 32, wherein, the control section stops outputting of the electrical energy from the power receiving section when the magnitude of a current flowing through the second switch is approximately the same as the magnitude of a current flowing through the storage battery.
